(19) United States
(12) Patent Application Publication
(10) Pub. No.: US 2018/0373569 A1
(43) Pub. Date: Dec. 27, 2018

(54) SYSTEM FOR LINKING ALTERNATE RESOURCES TO RESOURCE POOLS AND ALLOCATING LINKED ALTERNATIVE RESOURCES TO A RESOURCE INTERACTION

(71) Applicant: BANK OF AMERICA CORPORATION, Charlotte, NC (US)

(72) Inventors: Tracy Beth Greene, Mooresville, NC (US); Frederika Zipporah Morris Angus, Charlotte, NC (US); Emily Paige Bosin, Charlotte, NC (US); Kathleen Miranda Brand, Charlotte, NC (US); William Bradley Burks, Charlotte, NC (US); Deepak Joseph, Charlotte, NC (US); Karla Ramirez, Charlotte, NC (US); Laura Elizabeth Randall, Davidson, NC (US)

(21) Appl. No.: 15/630,381

(22) Filed: Jun. 22, 2017

(51) Int. Cl. G06F 9/50

(52) U.S. Cl. CPC G06F 9/5077; G06F 9/5061; G06F 9/46; G06F 9/5072; G06F 9/5005

(57) ABSTRACT

A system for digitally linking alternate resources to resource pools and allocating linked alternate resources to resource interactions. In specific embodiments, in response to allocating the alternate resource to the resource interaction, resources are re-allocated to the resource pool from which the resource interaction was initiated.

### FIELD OF THE INVENTION

The present invention is generally directed to processing resources and, more specifically, a system for linking alternated resources to resource pools and subsequently allocate the linked resources to a resource interaction.

### BACKGROUND

In many instances alternative resources are not fully utilized or in some instances may not be utilized at all. In addition, the usage of alternative resources may be difficult to track.

A need exists to develop systems, methods and the like that provide for alternate resources to be fully utilized. The desired systems, methods and the like should allow for the alternate resources to be allocated to a resource interaction without requiring entities to have knowledge of the allocation. In addition, a need exists to develop systems, methods and the like that provide ease in tracking usage of alternate resources. Moreover, a need exists to provide for digital means for transferring alternate resource between entities.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing systems, apparatus, methods, computer program product and/or the like for digitally linking alternate resources to resource pools and allocating linked alternate resources to resource interactions. In specific embodiments, in response to allocating the alternate resource to the resource interaction, resources are provide to the resource pool from which the resource interaction was initiated in a quantity equal to the portion of the alternative resources allocated to the interaction.

Thus, the present invention serves to assure that alternate resources are fully utilized. Moreover, the present invention results in allocation/utilization of alternate resources without requiring presence of the alternate resource at resource interaction or for an entity to have knowledge of the alternate resource allocation. In addition, the present invention tracking provide a means for tracking usage of alternate resources and provides a means for digitally transferring alternate resource between entities.

A system for allocating use of an alternative resource defines first embodiments of the invention. The system includes an alternative resource linking sub-system that includes a first memory and at least one first processor in communication with the first memory. The first processor is configured to receive a use code of an alternative resource associated with a first interaction entity, and based on the use code, link the alternative resource to one or more resource pools associated with a second interaction entity. The system further includes an alternative resource allocation sub-system in communication, via a distributed computing network, with the alternative resource linking sub-system and including a second memory and at least one second processor in communication with the second memory. The second processor is configured to determine an occurrence of a resource interaction between the first interaction entity and the second interaction entity using resources from one of the resource pools, and, in response to determining the occurrence of the resource interaction and based on the alternative resource being linked to the one of the resource pools, allocate at least a portion of the alternative resources to the resource interaction.

In specific embodiments the system further includes a resource re-allocation sub-system in communication, via the distributed computing network, with the alternative resource allocation sub-system and including a third memory and at least one third processor in communication with the third memory. The third processor is configured to, in response to the alternative resource allocation sub-system allocating at least a portion of the alternative resource to the resource transaction, provide resources in a quantity equal to the at least portion of the alternative resources to the at least one of the resource pools.

In still further specific embodiments the system includes an entity portal sub-system an entity portal sub-system in communication, via the distributed computing network, with the alternative resource linking sub-system and the alternative resource allocation sub-system and including a third memory and at least one third processor. The third processor is configured to generate and present, on a display of computing device, at least one user interface that is accessible to the second interaction entity and configured to indicate the link between the alternative resource and the one or more resource pools. In related embodiments the third processor of the entity portal sub-system is further configured to generate and present the at least one user interface that is configured to indicate at least one of (i) current resource balance associated with the alternative resource and/or (ii) one or more resource interactions in which the alternative resources was allocated to the resource interaction and at least one of (a) a quantity of the alternative resource allocated to a corresponding resource interaction, or (b) a quantity of resources re-allocated to the at least one of the resource pools. In further related embodiments of the system the third processor of the entity portal sub-system is further configured to generate and present the at least one user interface that is configured to allow the second interaction entity to select an option that invokes the alternative resource linking sub-system to de-link the alternative resource from at least one of the one or more resource pools.

In additional specific embodiments the system further includes an alternate resource transfer sub-system in communication, via the distributed computing network, with the alternative resource linking sub-system and including a third memory and at least one third processor in communication with the third memory. The third processor is configured to receive an input from the second interaction entity that selects (i) a third-party entity and (ii) at least a portion of the alternative resource transfers and, in response to selecting, transfers at least a portion of the alternative resource to the third-party entity. In related embodiments of the system the third processor of the alternate resource transfer sub-system is further configured to, in response to receiving an input from the second interaction entity that transfers an entirety of the alternative resource to the third-party entity, invoking the alternative resource linking sub-system to de-link the alternative resource from the one or more resource pools. In further related embodiments of the system, the first processor of the alternative resource linking sub-system is further configured to, in response to receipt of the alternative resource by the third-party entity, link the alternative resource to one or more resource pools associated with third-party entity. In other related embodiments the system includes an alternate resource acquisition sub-system in communication, via the distributed computing network, with the alternative resource linking sub-system and alternate resource transfer sub-system and including a fourth memory and at least one fourth processor in communication with the fourth memory. The fourth processor is configured to receive an input from the second interaction entity that selects (i) one or more alternative resources from amongst a plurality of alternative resources, and (ii) a third-party entity, and invokes the alternate resource transfer sub-system to transfer the selected one or more alternative resources to the third-party entity.

Moreover, additional embodiments of the system include an alternate resource acquisition sub-system in communication, via the distributed computing network, with the alternative resource linking sub-system and including a third memory and at least one third processor in communication with the third memory, wherein the third processor is configured to receive an input from the second interaction entity that (i) selects one or more alternative resources from amongst a plurality of alternative resources (ii) designates one of the resource pools for providing resources for acquiring the selected one or more alternative resources; and invokes the alternative resource linking sub-system to link the selected one or more alternative resources to one or more resource pools associated with a second interaction entity.

In further embodiments the system includes a gaming sub-system in communication, via the distributed computing network, with the alternative resource linking sub-system, the alternative resource allocation sub-system and the alternate resource acquisition subsystem and including a third memory and at least one third processor in communication with the third memory. The third processor is configured to provide the second interaction entity with one of alternative resources or redeemable resources in response to the second interaction entity performing one or more gaming tasks. In related embodiments the system includes an alternate resource acquisition sub-system in communication, via the distributed computing network, with the alternative resource linking sub-system and the gaming sub-system and including a fourth memory and at least one fourth processor in communication with the fourth memory. The fourth processor is configured to receive an input from the second interaction entity that (i) selects one or more alternative resources from amongst a plurality of alternative resources (ii) designates the redeemable resources for acquiring the selected one or more alternative resources.

In further specific embodiments the system includes a supplemental resource allocation sub-system in communication, via the distributed computing network, with the alternative resource linking sub-system and the alternative resource allocation sub-system and including a third memory and at least one third processor in communication with the third memory. The third processor is configured to (a) determine the occurrence of the resource interaction between the first interaction entity and the second interaction entity using resources from one of the resource pools, (b) determine that a supplemental resource is linked to the second interaction entity, and (c) in response to determining the occurrence of the resource interaction and based on the supplemental resource being linked to the second interaction entity, allocate the supplemental resource to the resource interaction.

A computer program product for allocating use of an alternative resource defines second embodiments of the invention. The computer program product includes at least one non-transitory computer readable medium having computer-readable program code portions embodied therein. The computer-readable program code portions include a first executable portion for receiving a use code of an alternative resource associated with a first interaction entity and a second executable portion for linking the alternative resource to one or more resource pools associated with a second interaction entity based on the use code. The computer-readable program portions further include a third executable portion for determining that an occurrence of a resource interaction between the first interaction entity and the second interaction entity using resources from one of the resource pools, and a fourth executable portion for, in response to determining the occurrence of the resource interaction and based on the alternative resource being linked to the one of the resource pools, allocating at least a portion of the alternative resources to the resource interaction.

A computer-implemented method for allocating use of an alternative resource defines third embodiments of the invention. The method includes receiving, by a computing device processor, a use code of an alternative resource associated with a first interaction entity and linking, by a computing device processor, the alternative resource to one or more resource pools associated with a second interaction entity based on the use code. The method further includes determining, by a computing device processor, an occurrence of a resource interaction between a first interaction entity and the second interaction entity using resources from one of the resource pools, and, in response to determining the occurrence of the resource interaction and based on the alternative resource being linked to the one of the resource pools, allocating, by a computing device processor, at least a portion of the alternative resources to the resource interaction.

Thus, according to embodiments of the invention, which will be discussed in greater detail below, the present invention provides for digitally linking alternate resources to resource pools and allocating linked alternate resources to resource interactions based on the interaction occurring with the entity associated with the alternate resource. Once the alternative resource is allocated, resources are reallocated to the resource pool from which the resource interaction was initiated. As such, the present invention insures that alternate resources are fully utilized, in that, alternate resources can be applied to an interaction without requiring presence of the alternate resource at the resource interaction or for an entity to have knowledge of the alternate resource allocation at the time of the interaction.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a schematic diagram illustrating a system for linking alternative resources and allocating the linked alternative resources to a resource interaction, in accordance with an embodiment of the invention;

FIG. 2 provides a schematic diagram illustrating a system for linking alternative resources and allocating the linked alternative resources to a resource interaction, in accordance with alternate embodiments of the invention;

FIG. 3 provides a block diagram illustrating the alternate resource linking sub-system, in accordance with an embodiment of the invention;

FIG. 4 provides a block diagram illustrating the alternate resource allocation sub-system, in accordance with an embodiment of the invention;

FIG. 5 provides a block diagram illustrating the resource entity portal sub-system, in accordance with an embodiment of the invention;

FIG. 6 provides a block diagram a user interface within the resource entity portal sub-system, in accordance with an embodiment of the invention;

FIG. 7 provides a flow diagram of a method for linking alternative resources and allocating linked resources to a resource interaction, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Thus, embodiments of the invention provide for digitally linking alternate resources, such as gift cards or the like, to resource pools, such as financial accounts or the like, and allocating linked alternate resources to resource interactions, such as purchase transactions or the like. In specific embodiments, in response to allocating the alternate resource to the resource interaction, resources are provide to the resource pool from which the resource interaction was initiated in a quantity equal to the portion of the alternative resources allocated to the interaction.

Thus, the present invention serves to assure that alternate resources, such as gift cards or the like, are fully utilized. Moreover, the present invention results in allocation/utilization of alternate resources without requiring presence of the alternate resource at resource interaction or without requiring that the entity/transactor to have knowledge of the alternate resource allocation at the time of the resource interaction.

In addition, the present invention provides for the alternate resources to visible to the entity through a portal interface, such as a mobile or online financial institution application/site. In this regard, the entity can track usage of the alternate resources (i.e., current alternate resource balance, previous resource interactions in which the alternate resource was allocated including amount of the allocation). In addition, the portal interface provides a means for the entity to link and/or de-link the alternative resource from one or more resource pools.

Moreover, the present invention provides for the digital transfer of previously linked alternate resource between entities and, in some embodiments of the invention, acquisition of alternate resources and subsequent transfer of the alternate resource to a different entity. In additional embodiments of the invention, an entity may acquire an alternate resource by applying resources from a resource pool associated with the entity or may earn the alternative resource through completion of activities, such as gaming activities or the like. In still further embodiments of the invention, in addition to allocating alternative resources to a resource interaction, supplemental resources, such as offers or the like, may be applied to a resource interaction to offset the amount of alternative resources needed to satisfy the resource interaction.

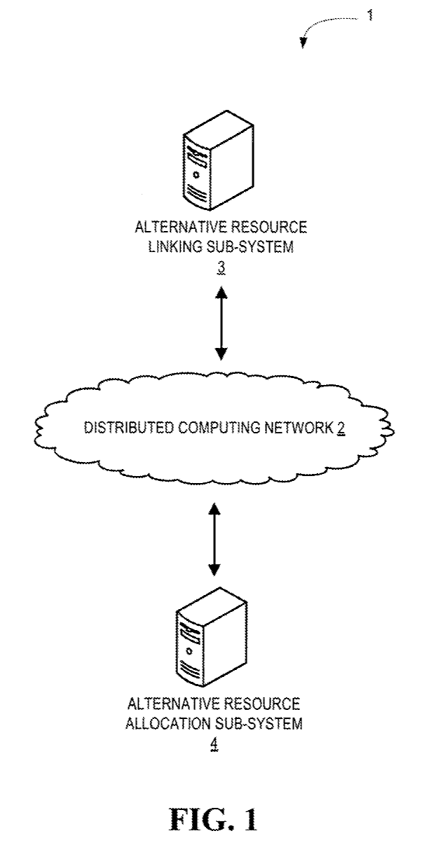

Referring to FIG. 1 a schematic diagram is shown of a system 1 for linking alternative resources and allocating linked alternative resources to a resource interaction, in accordance with embodiments of the present invention. It should be noted that while system 1 is described herein as implementing various sub-systems (i.e., modules, applications and the like) via a plurality of apparatus (e.g., computing platforms comprising servers, computing devices, memory devices and the like) the system 1 may include more or less sub-systems and may, in some embodiments, comprise one unified system 1 absent use of separate sub-systems. The system 1 is implemented via a distributed computing network 2, which may include the Internet, one or more intranets and/or combinations thereof for distributed data between sub-systems of the present invention. System 1 includes an alternative resource linking sub-system 3 that is configured to receive a use code associated with an alternative resource issued by a first interaction entity. In response to receiving the use code, and in some embodiments verifying at least the first interaction entity or the second interaction entity (i.e., the entity that input the use code), the alternative resource linking sub-system is configured to link the alternative resource to one or more resource pools associated with the second interaction entity. The resources pools may be predetermined resource pools designated by the second interaction entity or the resource pools may be selected by the second interaction entity in conjunction with receipt of the use code.

System 1 additionally includes an alternative resource allocation sub-system 4 that is configured to determine an occurrence of a resource interaction between the first interaction entity and the second interactions using resources from one of the resource pools to which the alternative resource is linked. Determination of the occurrence may occur post-resource interaction, such as by monitoring for the occurrence of resource interactions that have linked alternative resources. The alternative resource allocation sub-system 4 is further configured to, in response to determining the occurrence of the resource interaction and based on the alternative resource being linked to the resource pool from which the resource interaction occurred, allocate at least a portion of the alternative resources to the resource interaction.

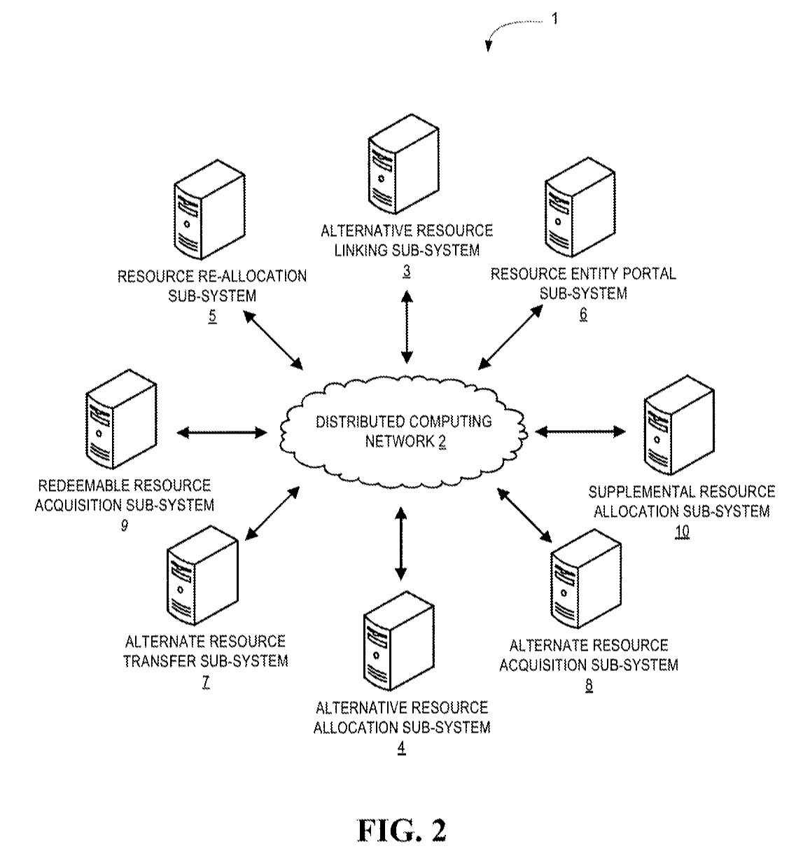

Referring to FIG. 2 a schematic diagram is shown of a system 1 for linking alternative resources and allocating linked alternative resources to a resource interaction, in accordance with additional embodiments of the present invention. As previously discussed in relation to FIG. 1, the system 1 is implemented via a distributed computing network 2, which may include the Internet, one or more intranets and/or combinations thereof for distributed data between sub-systems of the present invention.

System 1 includes an alternative resource linking sub-system 3 that is configured to receive a use code associated with an alternative resource issued by a first interaction entity. In specific embodiments of the invention, in which the alternative resource is a gift card and the first interaction entity is a merchant that issued the gift card, the use code may be received by the user/customer (i.e., the second interaction entity) capturing an image of the gift card that includes the use code, and communicating the image to the sub-system, which employs code for reading the indicia in the image. In other embodiments of the sub-system 3 may receive the use code through manual input by the user. Additionally, in such embodiments of the invention, sub-system 3 may be configured to verify the identity of the second interaction entity/user by requiring that the second interaction entity/user input predetermined user credentials (i.e., username and passcode) prior to receiving the use code or in conjunction with receiving the use code. Moreover, in other embodiments of the invention, the sub-system 3 may receive a first interaction entity identifier that identifies the first interaction entity/merchant. In specific embodiments of the system 1, the first interaction entity/merchant is required to be an active participant in the system 1 prior to linking the alternative resource/gift card to a resource pool (i.e., financial transaction account) associated with the second interaction entity/user).

In response to receiving the use code, and as discussed above, in some embodiments verifying active participation of the first interaction entity or the identity of the second interaction entity, the alternative resource linking sub-system 3 is configured to link the alternative resource to one or more resource pools associated with the second interaction entity. In those embodiments of the system 1, in which the alternative resource is a gift card, subsystem 3 is configured to link the gift card to one or more financial transaction accounts (i.e., resource pools) held by the user (i.e., second interaction entity). In such embodiments of the system 1, the financial transaction accounts to which the gift card is linked may be predetermined by the user or the financial transaction accounts may be selected by the user at the time of the linking procedure. As will be discussed infra., in specific embodiments of the invention, the system 1 is configured to allow the second interaction entity to add additional linked resource pools to the alternative resource and/or delink one or more, and in some instances all of the, resource pools from the alternative resource at any point in time. In those embodiments in which the alternative resource is a gift card, linking multiple financial transaction accounts to the gift card, allows the user to initially transact with the first interaction entity/merchant using any one of the multiple financial transaction accounts (e.g., debit account, credit account, loan account or the like) and subsequently allocating resources from the gift card (i.e., a least a portion of the current gift card balance) to the transaction.

System 1 additionally includes an alternative resource allocation sub-system 4 that is configured to determine an occurrence of a resource interaction between the first interaction entity and the second interaction entity using resources from one of the resource pools to which the alternative resource is linked. In those embodiments of the system in which the resource interaction is a financial transaction, the sub-system 4 is configured to determine that that the user has conducted a purchase transaction with the merchant associated with the gift card using one of the linked transaction accounts. Such a determination is typically made proximate to a time of settlement for the purchase transaction (i.e., prior to the financial institution issuing the transaction amount to the merchant). The alternative resource allocation sub-system 4 is further configured to, in response to determining the occurrence of the resource interaction and based on the alternative resource being linked to the resource pool from which the resource interaction occurred, allocate at least a portion of the alternative resources to the resource interaction. In those embodiment in which the alternative resource is a gift card, allocating provides for allocating at least a portion of the gift card balance to the purchase transaction. In specific embodiments, the system 1 is configured to allow the second interaction entity/user to define the amount of the gift card balance to be allocated to any one purchase transaction. For example, the system 1 may be configured to allow the user to allocate the entire outstanding balance of the gift card to the transaction (or the portion of the outstanding balance needed to satisfy the transaction in instances in which the outstanding gift card balance exceeds the transaction amount). In other embodiments of the invention, the system 1 may be configured to allow the user to designate a specified amount or percentage of remaining balance to be used for any purchase transaction. In other embodiments of the invention, the system 1 may be configured to notify the user, such as by alert/text or the like as designated by the user, at the time of the determination, such that the user is allowed to dynamically designate a specified portion of the gift card that the user desires to allocate to the transaction.

An optional embodiments the system 1 additionally includes resource re-allocation sub-system 5 that is configured to, in response to the alternative resource allocation sub-system allocating at least a portion of the alternative resource to the resource transaction, provide resources in a quantity equal to the at least portion of the alternative resources to the at least one of the resource pools. In those embodiments of the system 1 in which the alternative resource is a gift card, the portion of the gift card balance that is allocated to the purchase transaction is credited back to the user's transaction account(s) that are linked to the gift card and were used for the purchase transaction. In specific embodiments of the invention, the functionality of the resource re-allocation sub-system 5 is included within the alternative resource allocation sub-system 4, obviating the need for the resource re-allocation sub-system 5.

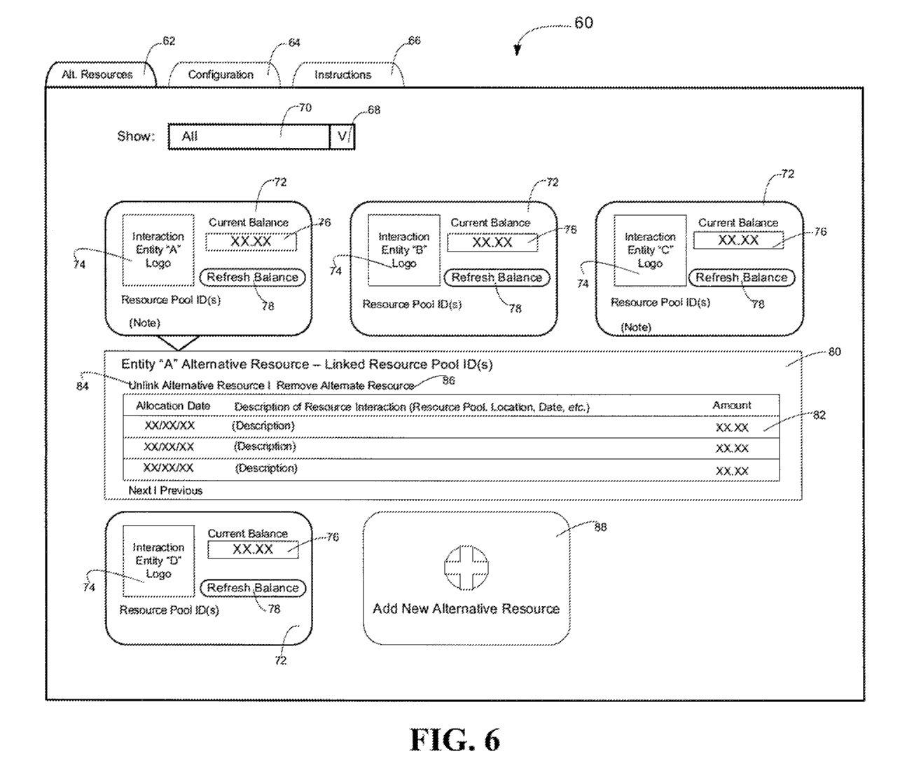

In additional embodiments the system 1 includes a resource entity portal sub-system 6. In those embodiments of the invention in which the alternative resource is a gift card, the resource entity portal may be any digital portal accessible to the user, such as online banking site, a mobile banking site or the like. The resource entity portal sub-system 6 is in communication, via the distributed computing network 2, with the alternative resource linking sub-system 3 and the alternative resource allocation sub-system 4 and is configured to generate and present, on a display of computing device, at least one user interface that is accessible to the second interaction entity and configured to indicate the link between the alternative resource and the one or more resource pools. In those embodiments of the system, in which the alternative resource is a gift card, the user interfaces may be displayed as part of supplemental resource user interfaces, such as financial institution offered deals that provide cash-back incentives to users who transact with a designated merchant. FIG. 6, which will be discussed infra. shows an exemplary user-interface of the resource entity portal configured to indicate the link between gift cards and one or more of the user's transaction accounts. In additional related embodiments the resource entity portal sub-system is configured to indicate a current alternate resource balance for the alternate resource, such as a gift card balance and an indication of the resource interactions in which the alternative resource was allocated, such as purchase transactions in which at least a portion of the gift card balance was allocated to the purchase transaction, including the quantity of alternative resources allocated to the resource interaction and/or the quantity of resources re-allocated to the resource pool(s), such as the portion of gift card balance allocated to the transaction, which is characteristically the same as the amount refunded to the transaction account.

In further embodiments the system 1 includes an alternate resource transfer sub-system 7 this is in communication, via the distributed computing network 2, with the alternative resource linking sub-system 3 and is configured to receive an input from the second interaction entity that selects (i) a third-party entity and (ii) at least a portion of the alternative resource and, in response to selecting, transfers at least a portion of the alternative resource to the third-party entity. In those embodiments of the system 1 in which the alternative resource is a gift card, a user may access the system 1, such as via the resource entity portal sub-system 6 or the like a transfer at least a portion of a gift card balance to another user (i.e., a friend, family member or the like). In this regard, the user accesses the transfer platform (resource entity portal or the like) and selects another user (via account ID, such as mobile telephone number or the like), a gift card and the portion of the gift card balance that the user desires to transfer. It should be noted that the portion of the gift card balance may be the remaining balance (i.e., transfer the gift card in full) or the portion may be less than the remaining balance, in which case a portion of the gift card balance remains with the transferor/user. In response to selecting another user/transferee and the portion of the gift card balance to transfer, a user input is received that digitally transfers at least a portion of the gift card to the other user. In the event that the user transfers the entire alternative resource, the alternative resource linking sub-system is invoked to de-link the alternative resource from the one or more resource pools and remove the alternative resources from the system 1. In those embodiments of the system in which the alternative resource is a gift card, transfer of the entire outstanding balance of the gift card, invokes the linking sub-system 3 to automatically de-link the gift card from the one or more transaction accounts and remove the gift card from the system 1. The other user may receive notification of the transfer, via a text/alert, email or the like, and, in the event the other user is associated with the system 1, the other user/transferee may be provided instructions for linking the gift card to one or more financial transaction accounts.

Moreover, in other embodiments the system 1 includes an alternate resource acquisition sub-system 8 that is in communication, via the distributed computing network, with the alternative resource linking sub-system and, in some embodiments of the system 1, the alternate resource transfer sub-system 7. The alternate resource acquisition sub-system 8 is configured to receive an input from the second interaction entity that selects (i) one or more alternative resources from amongst a plurality of alternative resources for acquisition. In those embodiments of the invention in which the alternative resource is a gift card, the user may access a gift card purchasing site, such as via the financial institution portal (e.g., online banking site or mobile banking application) to acquire/purchase gift cards and, in response to acquiring the gift card(s), invoke the alternative resource linking sub-system 3 to link the gift card(s) to one or more financial transaction accounts held by the user.

In other embodiments of the system, the alternative resource acquisition sub-system 8 is implemented in conjunction with the alternative resource transfer sub-system 7, such that the alternative resource acquisition sub-system 8 receives an input from the second interaction entity that selects (i) one or more alternative resources from amongst a plurality of alternative resources and (ii) a third-party entity and, in response to the selections, invokes the alternate resource transfer sub-system to transfer the selected one or more alternative resources to the third-party entity. In those embodiments of the invention in which the alternative resource is a gift card, the user selects one or more gift cards and a transfer recipient (i.e., friend, family member or the like) (via input of an account ID, such as mobile telephone number or the like), and the alternate resource transfer sub-system 7 is invoked to transfer the selected one or more gift cards to the other user/transferee.

In still further embodiments the system 1 includes a redeemable resource acquisition sub-system 9 that is in communication, via the distributed computing network 2, with the alternative resource linking sub-system 3, the alternative resource allocation sub-system 4 and the alternate resource acquisition subsystem 8. The redeemable resource acquisition sub-system 9 is configured to provide the second interaction entity with one of alternative resources or redeemable resources in response to the second interaction entity performing one or more gaming tasks. In those embodiments of the system 1 in which the alternative resource is gift card, the redeemable resource acquisition sub-system provides for the user to earn (i) points/rewards, which may be redeemed for gift cards and/or (ii) gift cards for performing game-like activities.

Further, in other embodiments the system 1 includes a supplemental resource allocation sub-system 10 that is in communication, via the distributed computing network 2, with the alternative resource linking sub-system 3 and the alternative resource allocation sub-system 4. The supplemental resource allocation sub-system is configured to (i) determine the occurrence of the resource interaction between the first interaction entity and the second interaction entity using resources from one of the resource pools, (ii) determine that a supplemental resource is linked to the second interaction entity, and (iii) in response to determining the occurrence of the resource interaction and based on the supplemental resource being linked to the second interaction entity, allocate the supplemental resource to the resource interaction. In those embodiments of the invention in which the supplemental resource is an offer/discount/deal associated with a merchant, the supplemental resource allocation sub-system is configured to (i) determine the occurrence of the purchase transaction between the merchant and the user using a financial payment account, (ii) determine that an offer/deal/discount is linked to the user, and (iii) in response to determining the occurrence of the purchase transaction and based on the offer/deal/discount being linked to the user, apply the offer/deal/discount to the purchase transaction. In those embodiments of the invention in which an alternative resource is also linked to the first interaction entity, the alternative resource may be allocated to the resource interaction after the supplemental resource is applied to the resource interaction. In those embodiments of the invention in which the alternative resource is a gift card and the supplemental resource is an offer/discount/deal, the offer/deal/discount may be applied to the purchase transaction prior to allocating the gift card to the purchase transaction.

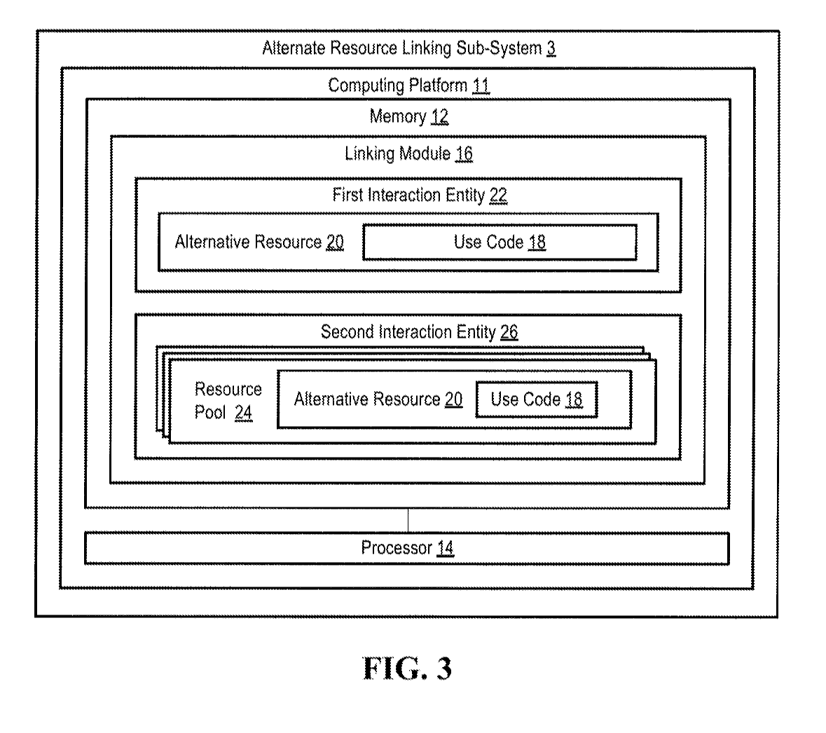

Referring to FIG. 3 shown is a block diagram of an alternative resource linking sub-system 3, in accordance with embodiments of the present invention. The sub-system 3 includes a computing platform 11, which may include one or more computing devices. The computing platform includes a memory 12 and at least one processor 14 in communication with the memory. Memory 12 may comprise volatile and non-volatile memory, such as read-only and/or random-access memory (RAM and ROM), EPROM, EEPROM, flash cards, or any memory common to computer platforms). Moreover, memory 12 may comprise cloud storage, such as provided by a cloud storage service and/or a cloud connection service.

Further, computing platform 11 also includes processor 14, which may be an application-specific integrated circuit (“ASIC”), or other chipset, logic circuit, or other data processing device. Processor 14 may execute an application programming interface (“API”) (not shown in FIG. 3) that interfaces with any resident programs, such as linking module 16 and sub-routines associated therewith or the like stored in the memory 12 of the alternate resource linking sub-system 3.

Processor 14 may include various processing subsystems (not shown in FIG. 3) embodied in hardware, firmware, software, and combinations thereof, that enable the functionality of sub-system 3 and the operability of the sub-system on a distributed computing network 2. For example, processing subsystems allow for initiating and maintaining communications and exchanging data with other networked sub-systems. For the disclosed aspects, processing subsystems of processor 14 may include any subsystem used in conjunction with linking module 16 and related sub-routines, algorithms, sub-algorithms, modules, sub-modules thereof.

Computer platform 11 may additionally include a communications module (not shown in FIG. 3) embodied in hardware, firmware, software, and combinations thereof, that enables communications between the sub-system 3 and other sub-systems (shown in FIG. 2). Thus, communication module may include the requisite hardware, firmware, software and/or combinations thereof for establishing and maintaining a network communication connection.

Memory 12 of alternate resource linking sub-system 3 stores linking module 16 that is configured to receive a use code 18 associated with an alternative resource 20 issued by a first interaction entity 22. In specific embodiments of the invention, in which the alternative resource 20 is a gift card and the first interaction entity 22 is a merchant that issued the gift card, the use code may be received by the user/customer (i.e., the second interaction entity 26) capturing an image (i.e., taking a photograph) of the gift card that includes the use code, and communicating the image to the linking module 16, which employs code for reading the indicia in the image. In other embodiments of the sub-system 3 may receive the use code through manual input by the user. Additionally, in such embodiments of the invention, linking module 16 may be configured to verify the identity of the second interaction entity/user 26 by requiring that the second interaction entity/user 26 input predetermined user credentials (i.e., username and passcode) prior to receiving the use code 18 or in conjunction with receiving the use code 18. Moreover, in other embodiments of the invention, the linking module 16 may receive a first interaction entity identifier that identifies the first interaction entity/merchant 22. In specific embodiments of the system 1, the first interaction entity 22/merchant is required to be an active participant in the system 1 prior to linking the alternative resource 20/gift card to a resource pool 24 (i.e., financial transaction account) associated with the second interaction entity/user).

In response to receiving the use code 18, and as discussed above, in some embodiments verifying active participation of the first interaction entity 22 or the identity of the second interaction entity 26, the linking module 16 is configured to, based on the use code 18, link the alternative resource 20 to one or more resource pools 24 associated with the second interaction entity 26. In those embodiments of the system 1, in which the alternative resource 20 is a gift card, linking module 16 is configured to link the gift card to one or more financial transaction accounts (i.e., resource pools 24) held by the user (i.e., second interaction entity 26). In such embodiments of the system 1, the financial transaction accounts to which the gift card is linked may be predetermined by the user or the financial transaction accounts may be selected by the user at the time of the linking procedure. As will be discussed infra., in specific embodiments of the invention, the system 1 is configured to allow the second interaction entity to add additional linked resource pools 24 to the alternative resource 20 and/or delink one or more, and in some instances all of the, resource pools 24 from the alternative resource at any point in time. In those embodiments in which the alternative resource 20 is a gift card, linking multiple financial transaction accounts to the gift card, allows the user to initially transact with the first interaction entity 26/merchant using any one of the multiple financial transaction accounts (e.g., debit account, credit account, loan account or the like) and subsequently allocate resources from the gift card (i.e., a least a portion of the current gift card balance) to the transaction.

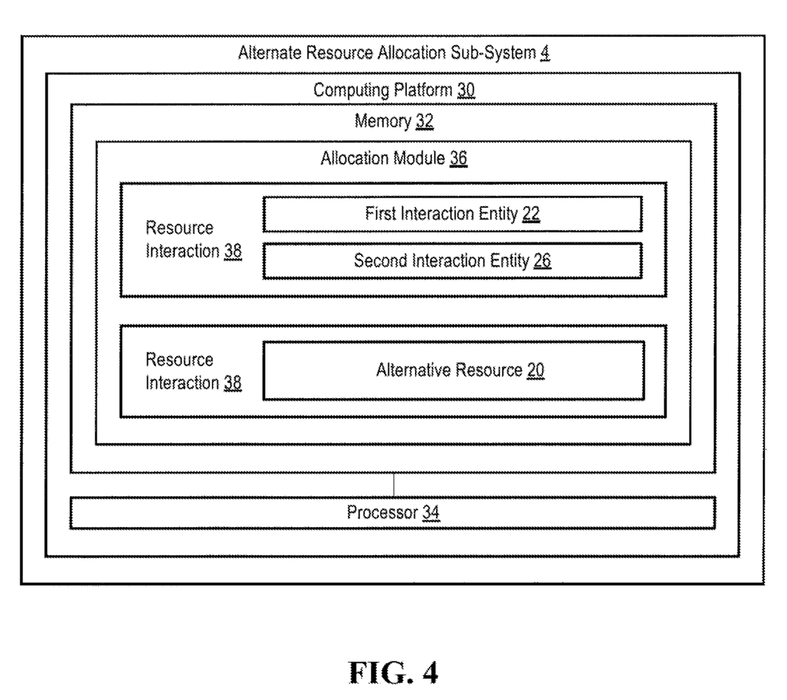

Referring to FIG. 4 shown is a block diagram of an alternative resource allocation sub-system 4, in accordance with embodiments of the present invention. The sub-system 4 includes a computing platform 30, which may include one or more computing devices. The computing platform 30 includes a memory 32 and at least one processor 34 in communication with the memory 32. Memory 32 may comprise volatile and non-volatile memory, such as read-only and/or random-access memory (RAM and ROM), EPROM, EEPROM, flash cards, or any memory common to computer platforms). Moreover, memory 32 may comprise cloud storage, such as provided by a cloud storage service and/or a cloud connection service.

Further, computing platform 30 also includes processor 34, which may be an application-specific integrated circuit (“ASIC”), or other chipset, logic circuit, or other data processing device. Processor 34 may execute an application programming interface (“API”) (not shown in FIG. 4) that interfaces with any resident programs, such as allocation module 36 and sub-routines associated therewith or the like stored in the memory 32 of the alternate resource allocation sub-system 4.

Processor 34 may include various processing subsystems (not shown in FIG. 4) embodied in hardware, firmware, software, and combinations thereof, that enable the functionality of sub-system 4 and the operability of the sub-system on a distributed computing network 2. For example, processing subsystems allow for initiating and maintaining communications and exchanging data with other networked sub-systems. For the disclosed aspects, processing subsystems of processor 34 may include any subsystem used in conjunction with allocation module 36 and related sub-routines, algorithms, sub-algorithms, modules, sub-modules thereof.

Computer platform 30 may additionally include a communications module (not shown in FIG. 4) embodied in hardware, firmware, software, and combinations thereof, that enables communications between the sub-system 4 and other sub-systems (shown in FIG. 2). Thus, communication module may include the requisite hardware, firmware, software and/or combinations thereof for establishing and maintaining a network communication connection.

Memory 32 of alternate resource allocation sub-system 4 stores allocation module 36 that is configured to determine an occurrence of a resource interaction 38 between the first interaction entity 22 and the second interaction entity 26 using resources from one of the resource pools 24 to which the alternative resource 20 is linked. In those embodiments of the system in which the resource interaction 38 is a financial transaction, the allocation module 36 is configured to determine that that the user has conducted a purchase transaction with the merchant associated with the gift card using one of the linked transaction accounts. Such a determination is typically made proximate to a time of settlement for the purchase transaction (i.e., prior to the financial institution issuing the transaction amount to the merchant).

The allocation module 36 is further configured to, in response to determining the occurrence of the resource interaction 38 and based on the alternative resource 20 being linked to the resource pool 24 from which the resource interaction 38 occurred, allocate at least a portion of the alternative resource 20 to the resource interaction 38. In those embodiment in which the alternative resource 20 is a gift card, allocating provides for allocating at least a portion of the gift card balance to the purchase transaction. In specific embodiments, the system 1 is configured to allow the second interaction entity 26/user to define the amount of the gift card balance to be allocated to any one purchase transaction. For example, the system 1 may be configured to allow the user to allocate the entire outstanding balance of the gift card to the transaction (or the portion of the outstanding balance needed to satisfy the transaction in instances in which the outstanding gift card balance exceeds the transaction amount). In other embodiments of the invention, the system 1 may be configured to allow the user to designate a specified amount or percentage of remaining balance to be used for any purchase transaction. In other embodiments of the invention, the system 1 may be configured to notify the user, such as by alert/text or the like as designated by the user, at the time of the determination, such that the user is allowed to dynamically designate a specified portion of the gift card that the user desires to allocate to the transaction.

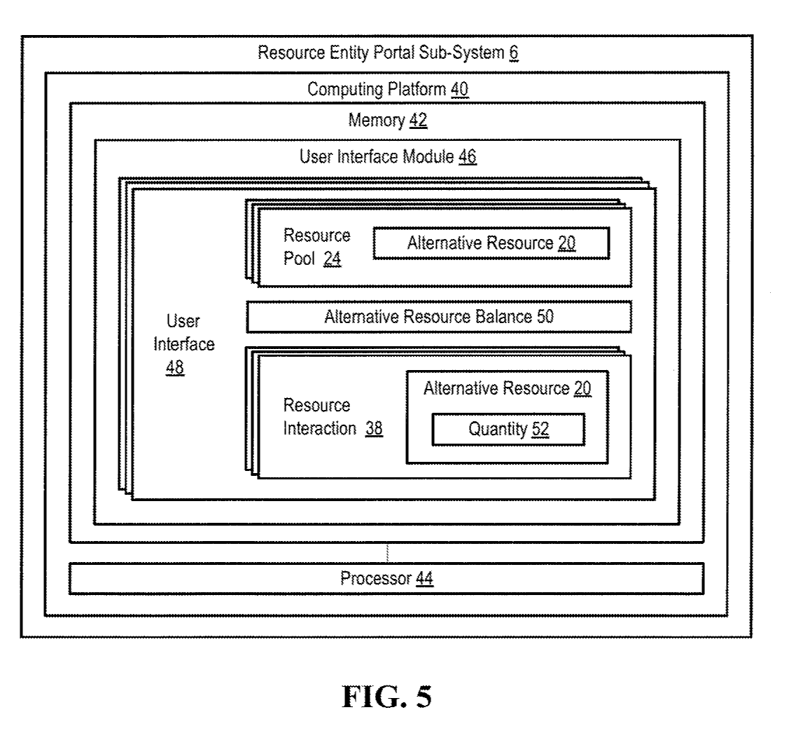

Referring to FIG. 5 shown is a block diagram of a resource entity portal sub-system 6, in accordance with embodiments of the present invention. The sub-system 6 includes a computing platform 40, which may include one or more computing devices. The computing platform 40 includes a memory 42 and at least one processor 44 in communication with the memory 42. Memory 42 may comprise volatile and non-volatile memory, such as read-only and/or random-access memory (RAM and ROM), EPROM, EEPROM, flash cards, or any memory common to computer platforms). Moreover, memory 42 may comprise cloud storage, such as provided by a cloud storage service and/or a cloud connection service.

Further, computing platform 40 also includes processor 44, which may be an application-specific integrated circuit (“ASIC”), or other chipset, logic circuit, or other data processing device. Processor 44 may execute an application programming interface (“API”) (not shown in FIG. 5) that interfaces with any resident programs, such as allocation module 36 and sub-routines associated therewith or the like stored in the memory 42 of the a resource entity portal sub-system 4.

Processor 44 may include various processing subsystems (not shown in FIG. 5) embodied in hardware, firmware, software, and combinations thereof, that enable the functionality of sub-system 6 and the operability of the sub-system 6 on a distributed computing network 2. For example, processing subsystems allow for initiating and maintaining communications and exchanging data with other networked sub-systems. For the disclosed aspects, processing subsystems of processor 44 may include any subsystem used in conjunction with user interface module 46 and related sub-routines, algorithms, sub-algorithms, modules, sub-modules thereof.

Computer platform 40 may additionally include a communications module (not shown in FIG. 5) embodied in hardware, firmware, software, and combinations thereof, that enables communications between the sub-system 6 and other sub-systems (shown in FIG. 2). Thus, communication module may include the requisite hardware, firmware, software and/or combinations thereof for establishing and maintaining a network communication connection.

Memory 42 of alternate resource allocation sub-system stores user interface module 46 that is configured to generate and present, in a display of a computing device, one or more user interfaces 48 that are configured to indicate the link between an alternative resource 20 and one or more resource pools 24. In other embodiments of the system, the user interfaces are configured to indicate other information related to the linking and the alternative resource, such as, but not limited to, the current alternative resource balance 50, the one or more resource interactions 38 to which the alternate resource 20 was allocated and the associated details of the resource interaction 38 including, but not limited to, alternative resource allocation quantity 52, date of the resource interaction, location of the resource interaction and the like.

Referring to FIG. 6 an exemplary user interface 60 is shown for indicating linking of alternative resources, specifically gift cards to resource pools, specifically financial transaction accounts, in accordance with embodiments of the present invention. The user interfaces includes selectable tabs 62, 64 and 66 for displaying different user interfaces. In the illustrated embodiments shown in FIG. 6, the tabs include an alternate resource tab 62 for displaying linked alternate resources, a configuration tab 64 for allowing the user to configure alternate resource linking parameters (e.g., which accounts to link, notifications and the like), and an instructions tab 66 for providing the user instructions on how to use the alternate resource linking system. The user interface includes a drop-down menu 68 for selecting which alternative resources to display in the user interface 60. In the illustrated embodiment of FIG. 6, as indicated in the selection box 70, the user has selected “all” of the alternative resources for display within user interface 60.

In the illustrated example, user interface 60 displays four alternative resources 72, which represent the user's four linked alternative resources. According to specific embodiments of the invention comprise gift cards and, as such, are configured in the user interface 60 to match the general size and face-front of a gift card. The alternative resources 72 include a logo 74 or other identifier of the interaction entity associated with the alternative resource, e.g., the logo 74 of the merchant issuing the gift card. The alternative resource additional includes current balance window/box 76 that is configured to display the current alternative resource balance, such as the current gift card balance. In addition, the alternative resource includes a selectable key 78 configured for allowing the user to refresh the balance of the alternative resource by acquiring additional alternative resources, e.g., adding additional funds/credit to a gift card or the like. Selection of selectable key 78 will result in display of a pop-up type window configured to allow the user to acquire additional alternative resources. Additionally, the alternative resource 79 displays a resource pool identifier (e.g., last four-digits of a transaction account number or the like) and user-designated notes related to the alternative resource, which the user can define at the time of linking or any time thereafter. The notes may indicate how the alternative resource was acquired, the designated purpose of the alternative resource or the like.

The alternative resources 72 are configured in the user interface 60 as selectable icons, such that a user may select, i.e., click-on or provide another designated input, to display resource interactions associated with the linked alternative resource. In the illustrated embodiment of FIG. 6 the user has selected the upper left-hand alternative resource 72 (or the initial display of the user interface 60 is configured to display resource interactions associated with the upper left-hand alternative resource 72) as indicated by the arrow leading from the bottom edge of the upper left-hand corner alternative resource 72 to the resource interaction information window 80. The resource interaction display window 80 includes a scrollable listing of resource interaction, e.g., purchase transactions, in which the linked alternative resource was allocated to the resource interaction, e.g., the linked gift card was applied to the purchase transaction. The scrollable listing of resource interactions include the allocation data an amount of the allocation from the alternative resource and a description of the resource interaction including, but not limited to, the resource pool used in the resource interaction, the data of the resource interaction and the location of the resource interaction. Additionally, resource interaction window 80 is configured to provide selectable options for unlinking the alternative resource 84 from the designated resource pool and/or removing the alternative resource 86 from the system altogether. Additionally, user interface 60 includes a selectable icon 88 for adding/linking a new alternative resource. Upon selection of the icon 88 by the user, a pop-up window or the like is displayed that allows the user to enter the user code of the alternative resource, such as capturing an image of the alternative resource or manually inputting the user code of the alternative resource.

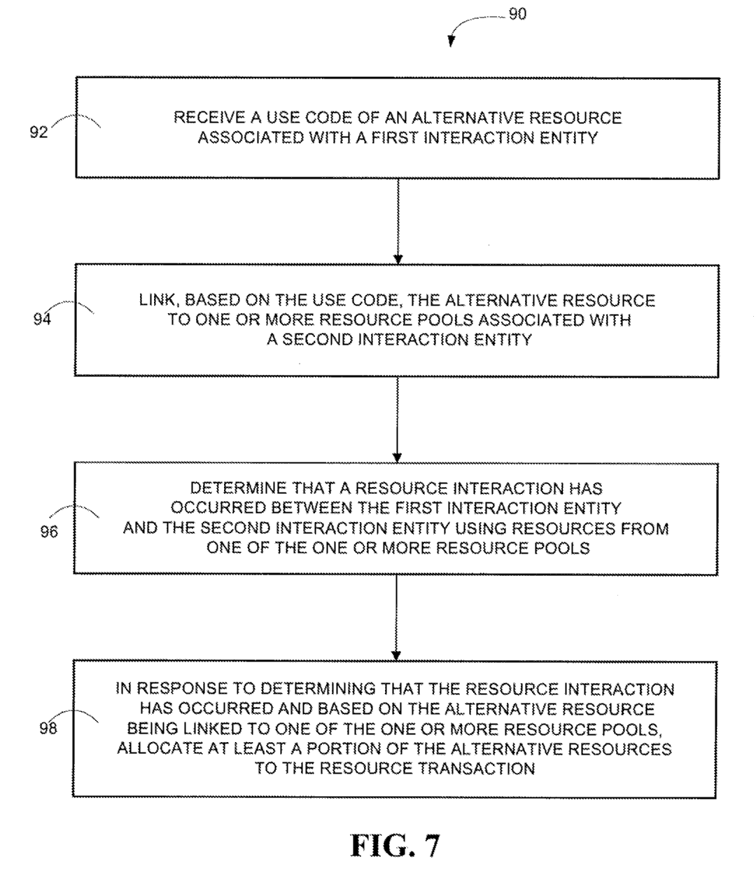

Referring to FIG. 7 a flow diagram is provide of a method 90 for linking and allocating alternative resources to a resource interaction, in accordance with embodiments of the present invention. In accordance with embodiments of the present invention the method herein described is a computer-implemented method, implemented via software (e.g., modules, applications, routines or the like), hardware (e.g., processors) or a combination of software and hardware. At Event 92, a use code of an alternative resource associated with a first interaction entity is received. In specific embodiments of the method, in which the alternative resource is a gift code, the use code may be received by capturing an image of the gift card, including the use code and transmitted the image to the system, which comprises code was reading the indicia in the image. In other embodiments of the method, the use code may be received through manual inputting by the second interaction entity/user.

At Event 94, based on the use code, the alternative resource is linked to one or more resource pools associated with the second interaction entity. The second interaction entity may predetermined one or more resource pools for linking alternative resources or the second interaction entity may dynamically define the resource pools at the time of the linking, at the time of the resource interaction or prior to settlement of the resource interaction. In those embodiments of the method, in which the alternative resource is a gift card, the gift card is linked to one or more financial transaction accounts (debit, credit, demand deposit, loan or the like) held by a user/customer.

At Event 96, an occurrence of a resource interaction between the first and second interaction entities using resources from one or more of the linked resource pools is determined to have occurred. In specific embodiments in which the alternative resource is a gift card, the occurrence of a purchase transaction between the user/customer and the merchant associated with the gift card using the linked transaction account is determined to have occurred. At Event 98, in response to the occurrence of the resource interaction and based on the alternative resource being linked to the one or more resource pools used in the resource interaction, at least a portion of the alternative resources are allocated to the resource interaction. In specific embodiments in which the alternative resource is a gift card, at least a portion of the outstanding gift card balance is allocated to the purchase transaction and the financial transaction account used to initially conduct the transaction is credited back the amount of the gift card balance allocated to the transaction.

Thus, as described above, embodiments of the present invention provide for systems, methods and the like for digitally linking alternate resources to resource pools and allocating linked alternate resources to resource interactions based on the interaction occurring with the entity associated with the alternate resource. Once the alternative resource is allocated, resources are reallocated to the resource pool from which the resource interaction was initiated. As such, the present invention insures that alternate resources are fully utilized, in that, alternate resources can be applied to an interaction without requiring presence of the alternate resource at the resource interaction or for an entity to have knowledge of the alternate resource allocation at the time of the interaction.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7880US1.014033.3038 | To be assigned | DYNAMIC UTILIZATION | Concurrently |
| | | OF ALTERNATIVE | herewith |
| | | RESOURCES BASED ON | |
| | | TOKEN ASSOCIATION | |
| 7881US1.014033.3039 | To be assigned | PROACTIVE RESOURCE | Concurrently |
| | | ACQUISITION BASED ON | herewith |
| | | ANTICIPATED NEED | |
| 7882US1.014033.3040 | To be assigned | DATA TRANSMISSION TO | Concurrently |
| | | A NETWORKED | herewith |
| | | RESOURCE BASED ON | |
| | | CONTEXTUAL INFORMATION | |
| 7883US1.014033.3041 | To be assigned | DATA TRANSMISSION | Concurrently |
| | | BETWEEN NETWORKED | herewith |
| | | RESOURCES | |

1. A system for allocating use of an alternative resource, the system comprising:
an alternative resource linking sub-system including a first memory and at least one first processor in communication with the first memory, wherein the first processor is configured to:
receive a use code of the alternative resource issued by a first interaction entity, and
based on the use code, link the alternative resource to one or more resource pools associated with a second interaction entity; and
an alternative resource allocation sub-system in communication, via a distributed computing network, with the alternative resource linking sub-system and including a second memory and at least one second processor in communication with the second memory, wherein the second processor is configured to:
determine an occurrence of a resource interaction between the first interaction entity and the second interaction entity using resources from one of the resource pools, and
in response to determining the occurrence of the resource interaction and based on the alternative resource being linked to the one of the resource pools, allocate at least a portion of the alternative resources to the resource interaction.

2. The system of claim 1, wherein further comprising a resource re-allocation sub-system in communication, via the distributed computing network, with the alternative resource allocation sub-system and including a third memory and at least one third processor in communication with the third memory, wherein the third processor is configured to:
in response to the alternative resource allocation sub-system allocating at least a portion of the alternative resource to the resource transaction, provide resources in a quantity equal to the at least portion of the alternative resources to the at least one of the resource pools.

3. The system of claim 1, further comprising an entity portal sub-system in communication, via the distributed computing network, with the alternative resource linking sub-system and the alternative resource allocation sub-system and including a third memory and at least one third processor, wherein the third processor is configured to:
generate and present, on a display of computing device, at least one user interface that is accessible to the second interaction entity and configured to indicate the link between the alternative resource and the one or more resource pools.

4. The system of claim 3, wherein the third processor of the entity portal sub-system is further configured to generate and present the at least one user interface that is configured to indicate a current alternate resource balance associated with the alternative resource.

5. The system of claim 3, wherein the third processor of the entity portal sub-system is further configured to generate and present the at least one user interface that is configured to indicate one or more resource interactions in which the alternative resources was allocated to the resource interaction and at least one of (i) a quantity of the alternative resource allocated to a corresponding resource interaction, or (ii) a quantity of resources re-allocated to the at least one of the resource pools.

6. The system of claim 3, wherein the third processor of the entity portal sub-system is further configured to generate and present the at least one user interface that is configured to allow the second interaction entity to select an option that invokes the alternative resource linking sub-system to de-link the alternative resource from at least one of the one or more resource pools.

7. The system of claim 1, further comprising an alternate resource transfer sub-system in communication, via the distributed computing network, with the alternative resource linking sub-system and including a third memory and at least one third processor in communication with the third memory, wherein the third processor is configured to:
receive an input from the second interaction entity that selects (i) a third-party entity, and (ii) at least a portion of the alternative resource and, in response to selecting, transfers at least a portion of the alternative resource to the third-party entity.

8. The system of claim 7, wherein the third processor of the alternate resource transfer sub-system is further configured to, in response to receiving the input from the second interaction entity that transfers an entirety of the alternative resource to the third-party entity, invoking the alternative resource linking sub-system to de-link the alternative resource from the one or more resource pools.

9. The system of claim 7, wherein first processor of the alternative resource linking sub-system is further configured to, in response to receipt of the alternative resource by the third-party entity, link the alternative resource to one or more resource pools associated with third-party entity.

10. The system of claim 7, further comprising an alternate resource acquisition sub-system in communication, via the distributed computing network, with the alternative resource linking sub-system and alternate resource transfer sub-system and including a fourth memory and at least one fourth processor in communication with the fourth memory, wherein the fourth processor is configured to:
receive a second input from the second interaction entity that selects (i) one or more alternative resources from amongst a plurality of alternative resources. and (ii) a second third-party entity, and
invokes the alternate resource transfer sub-system to transfer the selected one or more alternative resources to the second third-party entity.

11. The system of claim 1, further comprising an alternate resource acquisition sub-system in communication, via the distributed computing network, with the alternative resource linking sub-system and including a third memory and at least one third processor in communication with the third memory, wherein the third processor is configured to:
receive an input from the second interaction entity that (i) selects one or more alternative resources from amongst a plurality of alternative resources (ii) designates one of the resource pools for providing resources for acquiring the selected one or more alternative resources; and
invokes the alternative resource linking sub-system to link the selected one or more alternative resources to one or more resource pools associated with a second interaction entity.

12. The system of claim 1 further comprising a redeemable resource acquisition sub-system in communication, via the distributed computing network, with the alternative resource linking sub-system, and the alternative resource allocation sub-system and including a third memory and at least one third processor in communication with the third memory, wherein the third processor is configured to:
provide the second interaction entity with one of alternative resources or redeemable resources in response to the second interaction entity performing one or more gaming tasks.

13. The system of claim 12 further comprising an alternate resource acquisition sub-system in communication, via the distributed computing network, with the alternative resource linking sub-system and the redeemable resource acquisition sub-system and including a fourth memory and at least one fourth processor in communication with the fourth memory, wherein the fourth processor is configured to:
receive an input from the second interaction entity that (i) selects one or more alternative resources from amongst a plurality of alternative resources (ii) designates the redeemable resources for acquiring the selected one or more alternative resources.

14. The system of claim 1, further comprising a supplemental resource allocation sub-system in communication, via the distributed computing network, with the alternative resource linking sub-system and the alternative resource allocation sub-system and including a third memory and at least one third processor in communication with the third memory, wherein the third processor is configured to:
determine the occurrence of the resource interaction between the first interaction entity and the second interaction entity using resources from one of the resource pools,
determine that a supplemental resource is linked to the second interaction entity, and
in response to determining the occurrence of the resource interaction and based on the supplemental resource being linked to the second interaction entity, allocate the supplemental resource to the resource interaction.

15. A computer program product for allocating use of an alternative resource, the computer program product comprising at least one non-transitory computer readable medium having computer-readable program code portions embodied therein, the computer-readable program code portions comprising:
a first executable portion for receiving a use code of the alternative resource associated with a first interaction entity;
a second executable portion for linking the alternative resource to one or more resource pools associated with a second interaction entity based on the use code;
a third executable portion for determining an occurrence of a resource interaction between the first interaction entity and the second interaction entity using resources from one of the resource pools; and
a fourth executable portion for, in response to determining the occurrence of the resource interaction and based on the alternative resource being linked to the one of the resource pools, allocating at least a portion of the alternative resources to the resource interaction.

16. The computer program product of claim 15, wherein the computer-readable program code portions further include:
a fifth executable portion for, in response to allocating at least a portion of the alternative resource to the resource transaction, providing resources in a quantity equal to the at least portion of the alternative resources to the at least one of the resource pools.

17. The computer program product of claim 15, wherein the computer-readable program code portions further include:
a fifth executable portion for receiving an input from the second interaction entity that selects (i) a third-party entity and (ii) at least a portion of the alternative resource and, in response to selecting, transfers the at least a portion of the alternative resource to the third-party entity.

18. A computer-implemented method for allocating use of an alternative resource, the method comprising:
receiving, by a computing device processor, a use code of the alternative resource associated with a first interaction entity;
linking, by a computing device processor, the alternative resource to one or more resource pools associated with a second interaction entity based on the use code;
determining, by a computing device processor, an occurrence of a resource interaction between the first interaction entity and the second interaction entity using resources from one of the resource pools; and
in response to determining the occurrence of the resource interaction and based on the alternative resource being linked to the one of the resource pools, allocating, by a computing device processor, at least a portion of the alternative resources to the resource interaction.

19. The computer-implemented method of claim 18, further comprising in response to allocating at least a portion of the alternative resource to the resource transaction, providing resources in a quantity equal to the at least portion of the alternative resources to the at least one of the resource pools.

20. The computer-implemented method of claim 18, further comprising receiving an input from the second interaction entity that selects (i) a third-party entity and (ii) at least a portion of the alternative resource and, in response to selecting, transfers the at least a portion of the alternative resource to the third-party entity.
